(19) United States
(12) Patent Application Publication
(10) Pub. No.: US 2026/0357785 A1
(43) Pub. Date: Nov. 12, 2026

(54) SOFTWARE UPGRADE OF WIND TURBINE CONTROL SYSTEM

(71) Applicant: VESTAS WIND SYSTEMS A/S, Aarhus N (DK)

(72) Inventors: David STEELE, Skanderborg (DK); Jacob Barsøe KJÆRGAARD, Hinnerup (DK); Joao Pedro BARROS SILVA, Braga (PT); Diogo Alexandre DA SILVA LIMA, Viana do Castelo (PT); Francisco Nuno ALVES ORGE BASADRE, Fanzeres (PT); Benny BACH, Viby J (DK)

(21) Appl. No.: 19/121,589

(22) PCT Filed: Oct. 13, 2023
(86) PCT No.: PCT/DK2023/050244

§ 371 Date: Apr. 16, 2025

(30) Foreign Application Priority Data
Oct. 19, 2022 (DK) PA202270502

(51) Int. Cl. F03D 7/04; F03D 80/50; G06F 8/65

(52) U.S. Cl. CPC F03D 7/047; G06F 8/65; F03D 80/507

(57) ABSTRACT

A computer-implemented method of performing a software upgrade of a control system of a wind turbine, the control system comprising a network of nodes, the method comprising the steps of receiving and reading an upgrade request, and in response to the reading of the 5 upgrade request performing a query process in which one or more of the nodes is interrogated. Input is received from the query process and analysed to determine whether the upgrade request can be permitted. If permission is granted at least one of the nodes is upgraded with new software.

### FIELD OF THE INVENTION

The present invention relates to a computer-implemented method of performing a software upgrade of a control system of a wind turbine; a control system of a wind turbine configured to perform the method; and a computer program product.

### BACKGROUND OF THE INVENTION

In a distributed control system in a wind turbine, there are multiple processors present connected by some sort of network and/or fieldbus. In systems such as wind turbines, where functional safety is required, special hardware and software designed for handling safety-related functions are included in the set of processor nodes. Additionally, there may be other elements, such as network switches and other ancillary elements which are also necessary for interconnectivity of the processor nodes. All these processor nodes, together with these additional elements, provide overall control of the wind turbine.

It is a challenging task to upgrade software on such distributed control systems.

Interdependencies between functions running on the different processor nodes can cause functions to fail. This leads to unnecessary downtime as well as equipment wear when devices and actuators are abruptly stopped and can be particularly problematic for safety-related systems as their functions are similarly disrupted which can potentially result in unsafe states or force the safety system to be more rigid to compensate for these states, leading to more cost and complexity.

Failure can occur if upgrades to one or more of the processor nodes are performed while those processor nodes are operational. The loss of one processor node likely causes an error on another node on which it is dependent. It is also a typical feature of such a distributed control system, that the processor nodes run in very different paradigms, e.g. a condition monitoring system from a third party operates in a different way from a standard PLC for control operations or even more so compared to processor nodes handling functional safety which has severe constraints on its operation. This creates challenges in coordinating states between nodes.

Ancillary elements which include software, like network switches, smart sensors and actuators, are similarly in need of updating. These elements can also cause disruptions to functions which are distributed across multiple nodes and have the additional complexity that the software or firmware interface may not be available to the wind turbine developer outside of uploading new software to such devices.

A known solution to this problem is to shut down everything in the turbine to enable the upgrades to be performed. This has the disadvantage that safety or other critical functions are left unavailable, when this is not strictly necessary and risks damage to wind turbine components.

### SUMMARY OF THE INVENTION

A first aspect of the invention provides a computer-implemented method of performing a software upgrade of a control system of a wind turbine, the control system being a distributed control system comprising a network of nodes, the method comprising the steps of, while the wind turbine is in an operation state:
a) receiving and reading an upgrade request at a selected node of the distributed control system;
b) in response to the reading of the upgrade request in step a), performing a query process by the selected node to interrogate one or more of other nodes of the distributed control system;
c) at the selected node, receiving input from the query process of step b);
d) at the selected node, analysing the input from step c) to determine whether the upgrade request can be permitted;
e) by the selected node, granting permission based on the analysis of step d); and
f) in response to the granting of the permission in step e), determine an operating state during which the upgrade can be allowed, and
g) if the operating state is in an allowed state perform the upgrade request by upgrading at least one of the nodes with new software.

Upgrading of the software of one or more nodes is generally allowed if the wind turbine is in an operating state where the upgrading does not place the wind turbine at risk during the upgrade process. Operating states during which the upgrade can be allowed may be when the wind turbine is not operating in one of a number of operating states where the turbine may be placed at risk. Such non allowed operating states include, but are not limited to, an operating state with a high power output, operating states which are reliant on the functioning of the node to be upgraded or being reliant on a node which is depending of a functioning of the node to be upgraded, sensor signals indicating a special environmental situation or system situation, such as acceleration sensors indicating a high vibrational movement of a component, wind speed sensors indicating high wind speeds or turbulence, rotational speed sensors indicating a high or varying rotor speed,

Optionally step a) comprises reading configuration data; and step b) and/or step f) is performed based on the configuration data.

Optionally the configuration data determines which nodes are interrogated in step b); and/or the configuration data determines which nodes are upgraded in step g); and/or the configuration data determines an order in which nodes are upgraded in step g); and/or the configuration data determines which nodes are upgraded in parallel in step g).

Optionally the configuration data is part of the upgrade request received in step a), or the configuration data is read from storage in response to the receipt of the upgrade request in step a).

Optionally the method further comprises changing an operating state of the wind turbine as a result of the analysis of step d); and delaying the performance of step f) until the operating state of the wind turbine has changed.

Changing an operating state of the wind turbine may be the result of the operating state is not determined to be in an allowed state at step f). When the operating state of the wind turbine has changed to the allowed operating state, at least one of the nodes is upgraded with new software. Optionally at least one critical function of the wind turbine continues operating during the change of operating state.

Optionally the change of operating state causes a reduction of power generated by the wind turbine.

Optionally at least one of the nodes interrogated in step b) is incapable of performing any internal analysis.

Optionally a plurality of the nodes are upgraded in parallel in step g).

Optionally the input received in step c) or the analysis of step d) identifies a plurality of the nodes which can be upgraded in parallel; and the identified nodes are upgraded in parallel in step g). Optionally a plurality of the nodes are identified by the update request; a first subset of the nodes identified by the update request are upgraded in parallel in step g); and a second subset of the nodes identified by the update request are not upgraded in step g).

Optionally the input received in step c) or the analysis of step d) identifies the first subset of the nodes.

Optionally the input received in step c) is indicative of: a wind condition, and/or a power generated by the wind turbine.

Optionally each node upgraded in step g) is identified by the update request received in step a).

Optionally a plurality of the nodes are identified by the update request; and not all of the nodes identified by the update request are upgraded in step g).

Optionally not all nodes of the network are upgraded in step g).

Optionally each node upgraded in step g) is also interrogated in step b).

Optionally at least one node interrogated in step b) is not upgraded in step g).

Optionally the method further comprises: before step a), forwarding the upgrade request to the selected node functioning as a first upgrade arbiter; and following expiry of a timeout without receiving a response from the first upgrade arbiter, resending the upgrade request to another node of the distributed control system, the other node functioning as a second upgrade arbiter, wherein the second upgrade arbiter receives the upgrade request in step a) and then performs steps b)-e).

Optionally the method further comprises selecting the second upgrade arbiter from a plurality of further upgrade arbiters. The plurality of further upgrade arbiters being selected from the nodes of the distributed control system.

Optionally the upgrade request is a first upgrade request, and the method further comprises:
a1) receiving a second upgrade request at the selected node of the distributed control system;
b1) in response to the receipt of the second upgrade request in step a1), performing a query process by the selected node to interrogate one or more of the nodes of the distributed control system;
c1) at the selected node, receiving input from the query process of step b1);
d1) at the selected node, analysing the input from step c1) to determine whether the second upgrade request can be permitted;
e1) by the selected node, refusing permission based on the analysis of step d1; and
f1) in response to the refusal in step e1), aborting an upgrade process associated with the second upgrade request.

A further aspect of the invention provides a computer program product comprising software code adapted to perform a software upgrade of a control system of a wind turbine when executed on a data processing system, the computer program product being adapted to perform the method of the first aspect.

A further aspect of the invention provides a control system of a wind turbine configured to perform the method of the first aspect.

Optionally the control system comprises a network of nodes; an upgrade arbiter configured to perform steps a)-e) of the method; and a software upgrade server configured to perform step g) of the method.

### BRIEF DESCRIPTION OF THE DRAWINGS

Embodiments of the invention will now be described with reference to the accompanying drawings, in which:

FIG. 1 shows a wind turbine;

FIG. 2 shows a control system of the wind turbine;

FIG. 3 shows other elements of the control system; and

FIG. 4 shows a computer-implemented method of performing a software upgrade of the control system.

### DETAILED DESCRIPTION OF EMBODIMENT(S)

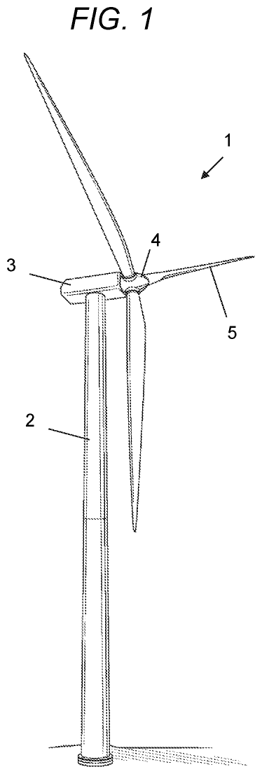

FIG. 1 shows a wind turbine 1 comprising a nacelle 3 mounted on a tower 2. A rotor 4, 5 is rotationally mounted to the nacelle 3. The rotor comprises a hub 4, and blades 5 extending from the hub. In this example, the rotor comprises three blades 5, but the number of blades can vary. The nacelle 3 can be rotated about a vertical yaw axis to change its yaw angle.

The wind turbine 1 may be included among a collection of other wind turbines belonging to a wind power plant, also referred to as a wind farm or wind park, that serve as a power generating plant connected by transmission lines with a power grid. The power grid generally consists of a network of power stations, transmission circuits, and substations coupled by a network of transmission lines that transmit the power to loads in the form of end users.

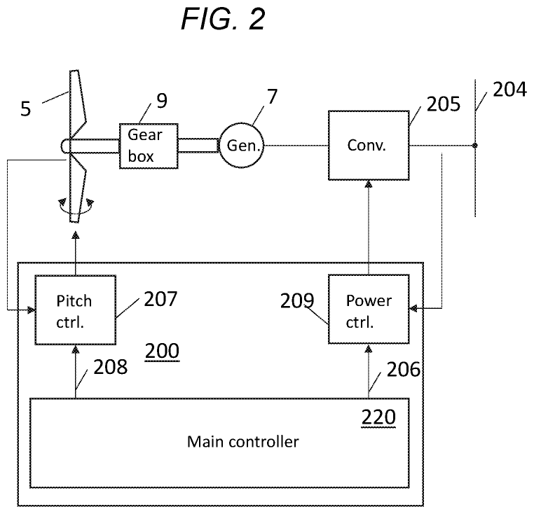

FIG. 2 schematically illustrates an embodiment of a control system 200 together with elements of the wind turbine 1. The rotor is mechanically connected to an electrical generator 7 via a gearbox 9 (in direct drive systems, and other systems, the gear box may not be present). The electrical power generated by the generator 7 is injected into a power grid 204 via an electrical converter 205. The electrical generator 7 and the converter 205 may be based on a full scale converter (FSC) architecture or a doubly fed induction generator (DFIG) architecture, but other types may be used.

The control system 200 comprises a number of elements, including at least one main controller 220 with a processor and a memory, so that the processor is capable of executing computing tasks based on instructions stored in the memory. In general, the main controller 220 ensures that in operation the wind turbine generates a requested power output level. This is obtained by adjusting the pitch angle of the blades and/or the power extraction of the converter 205. To this end, the control system 200 comprises a pitch system including a pitch controller 207 using a pitch reference signal 208, and a power system including a power controller 209 using a power reference signal 206. The rotor blades 5 can be pitched by a pitch mechanism. The rotor comprises an individual pitch system which is capable of individual pitching of the rotor blades 5, and a common pitch system which adjusts all pitch angles on all rotor blades at the same time. The control system 200, or elements of the control system 200, may be placed in a power plant controller (not shown) so that the turbine may be operated based on externally provided instructions.

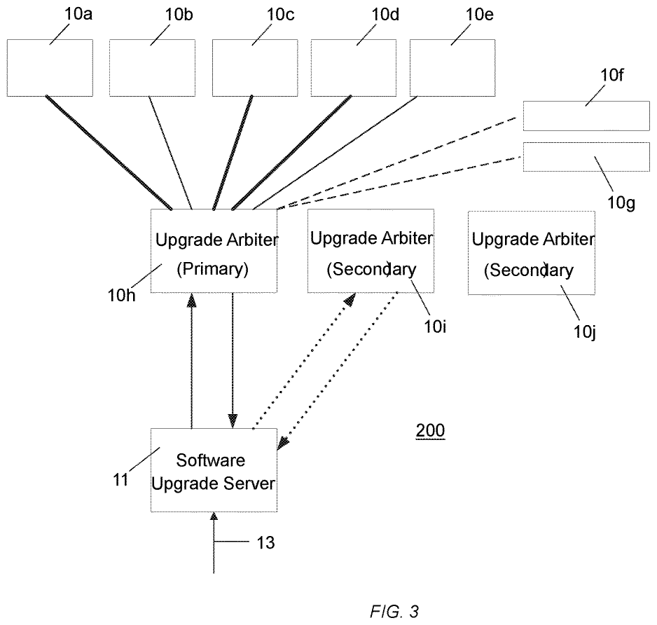

FIG. 3 illustrates other elements of the control system 200, including various elements configured to perform a software upgrade of the control system 200.

The control system 200 is a distributed control system comprises a network of nodes 10a-10j. Each node 10a-10h may comprise software which requires updating, optionally on a periodic basis. The software could be executable software, or configuration data, or any other type of software.

The nodes include processor/controller nodes 10a-10e which perform a processing or control function. By way of example each processor/controller node 10a-10e could be: a processor; a controller (for example controlling lubrication of the gearbox 9, or controlling hydraulic pumps of the pitch controller 207); a safety node (that is, a node handling functional safety); a switchgear (for example a circuit breaker or a switch-fuse device for protecting electrical equipment inside the wind turbine in the event of a fault condition); an embedded processor on a printed circuit board; or a standalone programmable logic controller.

The nodes 10f and 10g are ancillary devices. By way of example each node 10f, 10g could be a network switch (necessary for interconnectivity of the other nodes); a sensor (for example sensing speed of the rotor 5, condition of the gearbox 9, wind speed, movement of the tower 2, movement of the nacelle 3 or power output into the grid 204); or an actuator (for example a blade pitch actuator).

The node 10h is a primary upgrade arbiter, and the nodes 10i and 10j are secondary upgrade arbiters. In this example there are only two secondary upgrade arbiters 10i and 10j, but there may be more than two. The upgrade arbiters are nodes of the distributed control system which typically perform other functions, such as control functions, as well. The upgrade arbiters are selected nodes of the distributed control system, typically preselected and assigned to the arbiter task by pre-stored functionality, i.e. a programming code to execute the arbiter tasks.

The control system 200 also comprises a software upgrade server 11.

The upgrade arbiters 10h-j are nodes which are configured to grant or refuse requests from the software upgrade server 11 to perform software upgrades. The upgrade arbiters 10h-j interrogate nodes of the system to decide whether the requests can be permitted.

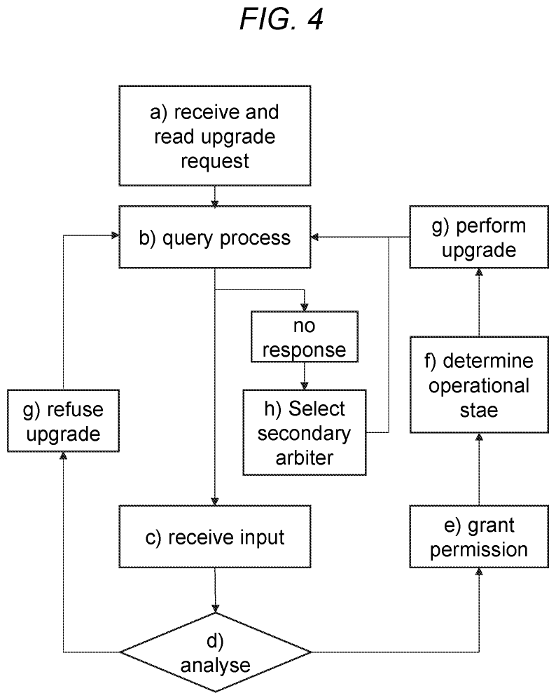

The software upgrade server 11 and upgrade arbiters 10h-10j are configured to perform a software upgrade of the control system 200 by the computer-implemented method steps shown in FIG. 4. More specifically the software upgrade server 11 and upgrade arbiters 10h-10j comprise a computer program product comprising software code adapted to perform the software upgrade when executed on a data processing system, the computer program product being adapted to perform the method shown in FIG. 4.

The computer program product may be provided on a computer readable storage medium or be downloadable from a communication network. The computer program product may comprise instructions to cause a data processing system, e.g. in the form of a controller, to carry out the instructions when loaded onto the data processing system.

A first step a) of the method shown in FIG. 4 comprises receiving and reading, at a selected node of the distributed control system, an upgrade request at the software upgrade server 11. This upgrade request is indicated at 13 in FIG. 3 and may come from a user (for instance service personnel), from an automated process remote from the wind turbine, or from a node of the control system 200. By way of example the upgrade request 13 may request an upgrade of nodes 10a, 10c, 10d, 10g.

Data in the upgrade request 3 may be read by the software upgrade server 11 to identify the nodes which are to be upgraded. Optionally, the upgrade request 3 may also include a configuration file containing configuration data about the nodes which are to be upgraded. Alternatively, the software upgrade server 11 may comprise local storage which contains configuration data for all nodes of the network.

The configuration data may explain an order in which the nodes are to be upgraded, as well as which nodes can be upgraded in parallel. Additional information of relevance (for instance upgrade order and timing) may also be included as needed.

The next steps of FIG. 4 comprise: b) in response to the reading of the upgrade request in step a), performing by the selected node a query process in which one or more of the nodes is interrogated; c) at the selected node, receiving input from the query process of step b); d) at the selected node, analysing the input from step c) to determine whether the upgrade request can be permitted; e) by the selected node, granting permission based on the analysis of step d); and f) in response to the granting of the permission in step e), determine an operating state during which the upgrade can be allowed, and g) if the operating state is in an allowed state perform the upgrade request by upgrading at least one of the nodes with new software. The new software could be executable software, or configuration data, or any other type of software.

if the operating state is not in an allowed state change the operating state to an allowed state and performing the upgrade request by upgrading at least one of the nodes with new software.

The software upgrade server 11 may request permission from the selected node acting as a primary upgrade arbiter 10h for the first set of upgrades which may be executed in parallel. In response, the primary upgrade arbiter 10h performs the query process of step b), receives input from the query process in step c), and analyses the input in step d) to determine whether the requested first set of upgrades is permitted under the current circumstances for the wind turbine.

Step b) interrogates one or more of the nodes 10a-10g, and step d) determines the suitability of the node(s) specified in the upgrade request to be upgraded, for instance by logical checks or other analysis.

For example, in very high wind conditions, it might not be safe to upgrade the turbine software due to risk of blade damage during the process. Also, assuming that this is permitted, some time may be required to take constructive action to put the turbine's systems and the whole turbine itself in an appropriate state to perform the updates.

At least one of the nodes interrogated in step b) may be a “non-smart” node which is incapable of performing any internal analysis. In this case the primary upgrade arbiter 10h assumes the role of verifying if it is OK to update that “non-smart” node.

The upgrade request 13 may specify nodes 10a, 10c, 10d, 10g. The query process of step b) may comprise interrogating all or some of the nodes 10a, 10c, 10d, 10h. Optionally the query process of step b) may comprise interrogating other nodes not specified in the upgrade request (for instance node 10b or ancillary device 10f).

Based on the analysis of step d), the primary upgrade arbiter 10h responds to the software upgrade server 11 with a decision. By way of example the decision may indicate whether the requested first set of upgrades may be immediately performed, whether some time is required to achieve the required state before allowing the upgrades, or whether the upgrades are not allowed at present for some reason.

In the event that the analysis of step d) indicates that the upgrades may be performed, the primary upgrade arbiter 10h may respond to the software upgrade server 11 with a decision at step e) that permission is granted. The software upgrade server 11 then performs the necessary upgrades in step g). The software upgrade server 11 waits until these are complete before going on to the next set of upgrades which may be performed in parallel, restarting from the query process of step b).

The analysis of step d) may indicate that the upgrades cannot be performed with the wind turbine in its current operating state, i.e. the wind turbine is not in an operating state during which the upgrade can be allowed. For example the input received in step c) may indicate a high speed wind condition and/or a high rotor speed, and/or a high power being generated by the wind turbine, such that performance of the upgrades is not possible. Alternatively the input received in step c) may indicate that a redundant node of the control system must be activated, or some function stopped or put in a special state before the upgrade is possible.

In one embodiment, the primary upgrade arbiter 10h may instruct the main controller 220 to change the operating state of the wind turbine, for instance changing the rotor speed or activating the redundant node. Once the operating state of the wind turbine has changed sufficiently (for instance the rotor speed has dropped below a threshold, a function has been stopped or put in a special state, or the redundant node has started operating) the primary upgrade arbiter 10h then grants permission at step e). In this embodiment, the operating state is changed to an allowed state.

In another embodiment, the primary upgrade arbiter 10h may grant permission at step e), but this permission is conditional on the operating state of the wind turbine being changed sufficiently before the software upgrades are performed. In this embodiment the software upgrade server 11 may instruct the main controller 220 to change the operating state of the wind turbine, for instance changing the rotor speed, stopping the function, putting the function in a special state, or activating the redundant node. Once the operating state of the wind turbine has changed sufficiently (for instance the rotor speed has dropped below a threshold, the function has stopped, or the redundant node has started operating) the software upgrade server 11 performs the upgrades in step g).

In both embodiments the performance of step g) is delayed until the operating state of the wind turbine has changed. The change in the operating state of the wind turbine might only be specific to a certain part of the turbine, while the rest of the wind turbine operates as before.

The change of operating state may cause a reduction of power generated by the wind turbine and supplied to the grid 204. Optionally the wind turbine continues supplying power to the grid 204 during the performance of the upgrade request in step g).

Typically at least one critical function of the wind turbine continues operating during the change of operating state and during the upgrade process of step g). That is, the wind turbine may not be completely shut down in order to perform the upgrades.

In the event that the analysis of step d) indicates that the upgrades cannot be performed, the primary upgrade arbiter 10h may respond to the software upgrade server 11 with a decision at step g) that permission is refused. The software upgrade server 11 may abort the upgrade at this stage and report relevant information to a user or log it as appropriate.

The primary upgrade arbiter 10h may specify in the refusal of step g) a reason or reasons for subsequent diagnosis by personnel. Optionally, if some time is required to achieve a state where the upgrades are allowed, the primary upgrade arbiter 10h may continue to update the software upgrade server 11 regarding the expected time remaining and indicate if the preparation process is completed early, thus allowing for time to be saved during the upgrades.

In the event of a lack of response from the primary upgrade arbiter 10h by a specified timeout, then the software upgrade server 11 may select one of the secondary upgrade arbiters 10i, 10j at step h) and then resend the request to the selected secondary upgrade arbiter, which starts the process again at step b). Alternatively, in the event of a lack of a response from the primary upgrade arbiter 10h by a specified timeout, the software upgrade server 11 may perform some default action which would typically be to proceed with the upgrades to avoid a deadlock or to abort the upgrades while the issue is investigated.

As noted above, configuration data may be provided. The configuration data may be part of the upgrade request 13 received in step a), or the configuration data may be read from storage in response to the receipt of the upgrade request in step a).

By way of example, the configuration data may identify which nodes are to be upgraded in step g); and/or an order in which nodes are to be upgraded in step g); and/or which nodes can be upgraded in parallel in step g). Step a) may comprise reading the configuration data; and the upgrade request in step g) may be performed based on the configuration data (for example the nodes may be upgraded in the specified order in step g).

Optionally some of the nodes to be upgraded are interdependent and can be upgraded in parallel. One example of an interdependency is between a switchgear node and other nodes which are possible sources of high voltage induced fire in the wind turbine. Another example of an interdependency is between a safety node, and other nodes which are monitored by the safety node to ensure safety. During normal operation, the safety node takes inputs from the other nodes so shutting down the safety node requires the other nodes to be shut down.

In one embodiment, the configuration data may indicate which nodes can be upgraded in parallel. For example the upgrade request 13 may specify nodes 10a, 10c, 10d, 10g and the configuration data may indicate that a first subset of the nodes (for example nodes 10c and 10d) are interdependent and can be upgraded in parallel. In this case, only the first subset of the nodes may be interrogated in the first iteration of steps b)-d) and upgraded in parallel in the first iteration of step g). The second subset of the nodes (for example nodes 10d and 10g) are not upgraded, at least in the first iteration of step g).

In an alternative embodiment, instead of the configuration data indicating which nodes can be upgraded in parallel, the input received in step c) or the analysis step d) may identify a first subset of the nodes (for instance nodes 10c and 10d) which can be upgraded in parallel. In this example, the output of the analysis step d) may be a permission to upgrade the first subset of the nodes in parallel, and a refusal to upgrade a second subset of the nodes (for example nodes 10a and 10g) at least at the present time. The interdependent nodes 10c and 10d indicated in the permission are then upgraded in parallel in the first iteration of step g).

The software upgrade server 11 may wait until the upgrade of nodes 10c and 10d is complete before going on to the next set of upgrades which may be performed in parallel (for instance nodes 10a and 10g), restarting from the query process of step b).

Typically each node upgraded in each iteration of step g) is identified by the update request 13 received in step a).

Optionally a plurality of the nodes may be associated with the update request 13; and not all of the nodes associated with the update request are upgraded in a single iteration of step g). For example the nodes 10a, 10c, 10d and 10g may be associated with the update request, but only the nodes 10c and 10d upgraded in the first iteration of step g).

Optionally not all nodes of the network are upgraded in step g).

Optionally each node upgraded in step g) is also interrogated in step b).

Optionally at least one node interrogated in step b) is not upgraded in step g).

Optionally an upgrade arbiter 10h-10j may itself contain internal nodes which are updated in step g).

The choice of arbiter 10h-10j may be configurable and may change not only between turbine versions but also by information about the current state of the turbine. For example, if part of the control system or its network is degraded, alternative sets of arbiters can be chosen.

The process of FIG. 4 may be repeated for a second upgrade request received in a repeat of step a). In this case, the other steps of the method are performed for that second upgrade request.

By way of example, the repeat of the process of FIG. 4 may comprise:
a1) receiving the second upgrade request at the selected node of the distributed control system;
b1) in response to the receipt of the second upgrade request in step a1), performing a query process by the selected node to interrogate one or more of the nodes of the distributed control system;
c1) at the selected node, receiving input from the query process of step b1);
d1) at the selected node, analysing the input from step c1) to determine whether the second upgrade request can be permitted;
e1) the selected node, refusing permission based on the analysis of step d1; and
f1) in response to the refusal in step e1), aborting an upgrade process associated with the second upgrade request.

### First Example

A first example of the process of FIG. 4 will now be described.

The arbiter 10h receives an upgrade request and interrogates sensor nodes (e.g. rotor speed sensors and/or power output sensors) which indicate that the wind turbine is operating at a high level. The arbiter 10h analyses this sensor data and does not give permission to perform the upgrade until the wind turbine is no longer operating at the high level. The primary upgrade arbiter 10h could cause the wind turbine to enter a safe state before granting permission in step e). In this example the arbiter 10h has a direct connection to sensors. In other examples, the arbiter 10h may only have indirect connection to sensors via other nodes. In that example the other nodes may perform a certain amount of analysis to come up with the answer. So the analysis step d) may only be partially performed within the arbiter 10h—i.e. it may be distributed around the nodes of the control system.

### Second Example

A second example of the process of FIG. 4 will now be described.

The arbiter 10f receives an upgrade request and interrogates a tower movement sensor and a nacelle movement sensor. These indicate a large amount of motion because there is a storm. The arbiter 10h does not give permission to perform the upgrade until the storm stops.

### Third Example

A third example of the process of FIG. 4 will now be described.

The arbiter 10h receives an upgrade request to upgrade a hydraulic pump control node. This node has an interdependence with blade pitch actuators—i.e. the blade pitch actuators cannot be operated when the hydraulic pump control node is off. So certain proactive action may be required before permission is granted in step e).

Although the invention has been described above with reference to one or more preferred embodiments, it will be appreciated that various changes or modifications may be made without departing from the scope of the invention as defined in the appended claims.

1. A computer-implemented method of performing a software upgrade of a control system of a wind turbine, the control system being a distributed control system comprising a network of nodes, the method comprising, while the wind turbine is in an operation state:
a) receiving and reading an upgrade request at a selected node of the distributed control system;
b) in response to the reading of the upgrade request in step a), performing a query process by the selected node to interrogate one or more of other nodes of the distributed control system;
c) at the selected node, receiving input from the query process of b);
d) at the selected node, analysing the input from step c) to determine whether the upgrade request can be permitted;
e) by the selected node, granting permission based on the analysis of d); and
f) in response to the granting of the permission in e), determine an operating state during which the upgrade can be allowed, and
g) when the operating state is determined to be in an allowed state, perform the upgrade request by upgrading at least one of the nodes with new software.

2. A method according to claim 1, wherein step a) comprises reading configuration data; and wherein b) and/or f) is performed based on the configuration data.

3. A method according to claim 2, wherein:
the configuration data determines which nodes are interrogated in b); and/or
the configuration data determines which nodes are upgraded in g); and/or
the configuration data determines an order in which nodes are upgraded in g); and/or
the configuration data determines which nodes are upgraded in parallel in g).

4. A method according to claim 2, wherein the configuration data is part of the upgrade request received in a), or the configuration data is read from storage in response to the receipt of the upgrade request in a).

5. A method according to claim 1, further comprising changing an operating state of the wind turbine as a result of the analysis of d); and delaying the performance of f) until the operating state of the wind turbine has changed.

6. A method according to claim 5, wherein at least one critical function of the wind turbine continues operating during the change of operating state.

7. A method according to claim 5, wherein the change of operating state causes a reduction of power generated by the wind turbine.

8. A method according to claim 1, wherein at least one of the nodes interrogated in step b) is incapable of performing any internal analysis.

9. A method according to claim 1, wherein a plurality of the nodes are identified by the update request; a first subset of the nodes identified by the update request are upgraded in parallel in g); and a second subset of the nodes identified by the update request are not upgraded in step g).

10. A method according to claim 1, wherein the input received in c) or the analysis of d) identifies the first subset of the nodes.

11. A method according to any preceding claim, further comprising:
before a), forwarding the upgrade request to a first upgrade arbiter; and
following expiry of a timeout without receiving a response from the first upgrade arbiter, resending the upgrade request to a second upgrade arbiter, wherein the second upgrade arbiter receives the upgrade request in a) and then performs b)-e).

12. A method according to claim 11, further comprising selecting the second upgrade arbiter from a plurality of further upgrade arbiters.

13. A computer program product comprising software code adapted to perform a software upgrade of a control system of a wind turbine when executed on a data processing system, the control system being a distributed control system comprising a network of nodes, the computer program product being adapted to perform an operation while the wind turbine is in an operation state, comprising:
a) receiving and reading an upgrade request at a selected node of the distributed control system;
b) in response to the reading of the upgrade request in a), performing a query process by the selected node to interrogate one or more of other nodes of the distributed control system;
c) at the selected node, receiving input from the query process of b);
d) at the selected node, analysing the input from c) to determine whether the upgrade request can be permitted;
e) by the selected node, granting permission based on the analysis of d); and
f) in response to the granting of the permission in e), determine an operating state during which the upgrade can be allowed, and
g) when the operating state is determined to be in an allowed state, perform the 1 upgrade request by upgrading at least one of the nodes with new software.

14. (canceled)

15. (canceled)
